(19) United States
(12) Patent Application Publication
(10) Pub. No.: US 2008/0209086 A1
(43) Pub. Date: Aug. 28, 2008

(54) Device To Be Used As An Interface Between A User And Target Devices

(75) Inventors: Thomas Portele, Bonn (DE); Peter Joseph Leonardus Antonius Swillens, Eindhoven (NL); Henricus Joseph Cornelus Kuijpers, Haler (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/575,690

(22) PCT Filed: Sep. 8, 2005
(86) PCT No.: PCT/IB05/52920

§ 371 Date: Mar. 21, 2007

(30) Foreign Application Priority Data
Sep. 22, 2004 (EP) 04104584.0

(51) Int. Cl. G06F 13/14

(52) U.S. Cl. 710/31

(57) ABSTRACT

This invention relates to a method of remotely controlling target devices via an interface device, based on an input from a user comprising information identifying at least one target device and an action to be performed on said at least one target device, wherein the interface device is adapted for directly transmitting a control signal based on said input in a direction towards said least one of said target device, wherein the transmission direction is controllable using setup data stored at said interface device, wherein the setup data is obtained during setup phase of the interface device and comprises: identification data for uniquely identifying said target devices, and direction data associated to each of said identification data for identifying said transmission direction, wherein based on the user's input to perform said action on said at least one target device, using the direction data associated to the identification data of said at least one target device for controlling the transmission direction towards said at least one target device.

The present invention relates to a method of remotely controlling target devices via an interface device, based on an input from a user comprising information identifying at least one target device and an action to be performed on said at least one target device, wherein the interface device is adapted for directly transmitting a control signal based on said input in a direction towards said least one of said target device, wherein the transmission direction is controllable using setup data stored at said interface device.

Most consumer electronic devices are controlled by infrared signals and a dedicated remote control. As each device has its own remote control, the number of necessary controls can be inconveniently high for a standard living room. To counter this development, so called “universal remote controls” have been developed which can handle the command set for several devices. Therefore several remote controls can be replaced with a single universal remote control. Since the user aims the remote control towards the target devices during control a low-power focussed reliable infrared signals and pertinent generator can be used.

For more advanced interfaces between a user and the consumer electronics equipment, like interfaces capable of performing spoken or multimodal dialogues, the interface does not need to remain in the user's hand. In such cases, the infrared signal must reach the target devices without the user aiming at it. One possible solution is an infrared blaster, which transmits the signal in multiple directions simultaneously in order to reach the destination. The problem with such blasters is that higher energy is required and a larger transmitter is needed. Also, misinterpretations by devices not targeted but, which are able to understand similar codes is possible.

It is therefore an object of the present invention to solve the above mentioned problems.

According to one aspect the present invention relates to a method of remotely controlling target devices via an interface device, based on an input from a user comprising information identifying at least one target device and an action to be performed on said at least one target device, wherein the interface device is adapted for directly transmitting a control signal based on said input in a direction towards said least one of said target device, wherein the transmission direction is controllable using setup data stored at said interface device, wherein the setup data is obtained during setup phase of the interface device and comprises:
identification data for uniquely identifying said target devices, and
direction data associated to each of said identification data for identifying said transmission direction,

wherein based on the user's input to perform said action on said at least one target device,
using the direction data associated to the identification data of said at least one target device for controlling the transmission direction towards said at least one target device.

Thereby, the possibility of misinterpretations by devices not targeted, but which are able to understand similar control signals, is excluded. Also, less energy is needed since the transmitted control signal is only pointed to specific target devices. In the case where the control signals are infrared signals, the use of a low-power infrared transmitter is possible.

In an embodiment, the input from said user comprises a speech signal.

Thereby, the user can control said target devices in a very convenient and user friendly way by using a speech command.

In an embodiment, the identification data are obtained through a speech signal from said user.

Therefore, the user can provide the control device with exact data identifying the target devices in a convenient way, wherein the identification data may be associated with an exact infrared code of said target devices. This may be done based on pre-stored database in the control device comprising various types of target devices along with the various infrared codes. As an example, since TV's have several sets of infrared codes, the correct infrared code is obtained for said TV if the necessary information for the TV is given.

In an embodiment, the direction data associated to each of said identification data comprises data are obtained using a computer vision device and the user as a reference point for said computer vision device.

Thereby, the pointing positions are determined in a fast and convenient way, where it is sufficient for the user to move to the target devices to generate a reference point for said computer vision device.

In an embodiment, the direction data associated to each of said identification data comprises data obtained using a computer vision device adapted to visual identify the target devices.

Thereby, the computer vision can identify the target object directly, e.g. using a visual scan, which identifies the target devices based on visual analysis of the images.

In an embodiment, the direction data comprises data obtained using an acoustic localization device and the user as a reference point and the user as a reference point for said acoustic localization device.

Thereby, it is sufficient for the user to move to the target devices and generate a speech signal in order to generate a target point for said device, which makes the initial setup phase very easy and user friendly.

In an embodiment, the method further comprises automatically performing commands on said target devices.

Therefore, the command may not necessarily be performed immediately or shortly after an interaction with the user. An example is where a user has programmed a show on TV to be recorded at a certain time, or to shut down the TV in 2 hours. Thereby, the controlling system may, based e.g. on some background process, automatically control the target devices. The control system would initiate the required control sequences (possibly for several devices that are involved) on its own at a later time without involvement of the user.

In another aspect the present invention relates to a computer readable medium having stored therein instructions for causing a processing unit to execute said method.

In a further aspect the present invention relates to a control device to be used as an interface between a user and target devices for remotely controlling said target devices based on an input from said user comprising information identifying at least one target device and an action to be performed on said at least one target device, wherein the control device comprises:
a transmitter for directly transmitting a control signal based on said input in a direction towards said least one of said target device,
a setup equipment to be used during a setup phase for obtaining setup data for said control device, wherein the setup data comprises identification data for uniquely identifying said target devices, and direction data associated to each of said identification data for identifying said transmission direction, and
a controller for, based on the user's input to perform said action on said at least one target device, controlling the transmission direction using the direction data associated to the identification data of said at least one target device.

In an embodiment, the setup equipment comprises a camera arranged on a rotator and a coordinate system connected to the rotator.

Therefore, during setup phase it is sufficient for the user to approach a target device wherein the user's approach is followed by the camera through the rotation of the rotator. After reaching a standstill position, the coordinate system may provide output data, e.g. spherical or cylindrical coordinate data, and associate said data with said identification data.

In an embodiment, the setup equipment comprises an acoustic sensor arranged on a rotator and a coordinate system connected to the rotator.

Therefore, instead of using said camera, the user's location is determined through an acoustic localization technique.

In an embodiment, the control device further comprises a dialogue system for extracting said information from the user input.

Therefore, the dialogue system notices by e.g. semantic analysis the content in the user's speech command, which makes the system very user friendly.

In the following preferred embodiments of the invention will be described referring to the figures, where

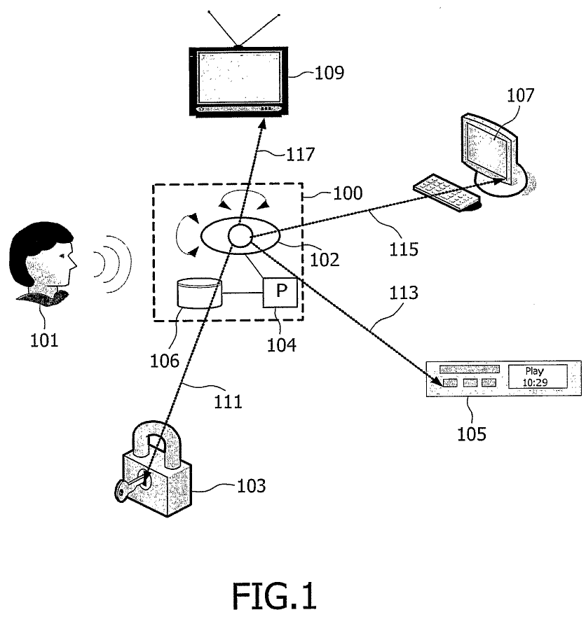

FIG. 1 shows a control device according to present invention to be used as an interface between a user and target devices, and

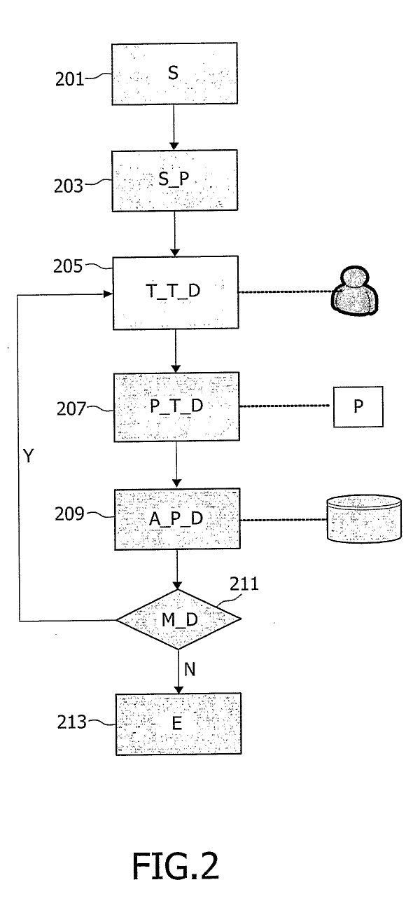

FIG. 2 shows a flow chart of one embodiment of a setup phase for the control device described in FIG. 1.

FIG. 1 illustrates a control device 100 according to the present invention to be used as an interface between a user 101 and target devices 103, 105, 107, 109 for remotely controlling the target devices 103, 105, 107, 109 based on an input from the user 101. This is done using a transmitter 102, e.g. an infrared transmitter, comprised in the control device 100 for transmitting an infrared control signal directly towards the target devices 103, 105, 107, 109, based on the user input, in a transmission direction 111, 113, 115, 117 which is controllable. The input from the user 101 comprises in one embodiment a speech signal comprising information identifying at least one target device and an action to be performed on the at least one target device. The speech signal may be analysed using dialogue system (not shown) based on semantic analysis. At least a part of the result from the semantic analysis is transferred to an infrared signal, which is transmitted to the target devices 103, 105, 107, 109 by the infrared transmitter 102. The user input may as an example comprise the speech command “turn on the TV” wherein the semantic items in the speech signal are transferred to an infrared signal which is transmitted towards the TV. This corresponds therefore to a user which presses the “turn on”-button on a remote control.

In order to enable the controlling of the transmission direction, an initial setup procedure of the control device 100 must be done. In the setup procedure the transmitter 102 is provided with direction data for identifying the transmission directions 111, 113, 115, 117 of the transmitter 102 towards the target devices 103, 105, 107, 109, and these direction data are associated with identification data which uniquely identifies the target devices 103, 105, 107, 109. In order to determine the various direction data for the transmitter 102 towards the target devices 103, 105, 107, 109, setup equipment is used. In one embodiment the setup equipment comprises a camera arranged on a rotator and a coordinate system connected to the rotator. Therefore, when the user 101 installs the first target device, the user provides the device 100 with identification data which uniquely identifies the target device. In one embodiment the user 101 approaches the target device to be installed and the user 101 is used as a reference point during the setup phase. The camera follows the user's position through the rotation provided by the rotator. When the user 101 is situated in front of a target device, e.g. a TV 109, he/she informs the device 100 about the identification of the target device TV 109. This could be done by informing the control device 100 that the target device is located nearby, e.g. by saying: “the TV type Philips 28PT5007 is located here”. Through a pre-stored data in the control device 100 the TV 109 is identified along with e.g. the infrared transmission code for that particular TV 109. Based on the current pointing position of the camera, the coordinate system provides output coordinate data, which are associated with the identified TV 109 and the transmission code of the transmission signal 117 for the TV. A processor 104 associates said data and stores them in the memory 106. This step is repeated for the subsequent target devices, so that the computer or the Home Entertainment System 107 has a second transmission direction 115, the VCR the third transmission direction 113 and the security system the fourth transmission direction 111. This needs to be carried out only once during setup.

The processor 104 controls the direction of the transmitter 102, which can be infrared LED, and therefore the transmission direction of the control signal. Therefore, when the user 101 instructs the device 100 to perform an action, e.g. turn on the TV 109, the user's speech command is processed by the dialogue system, which results in that the TV 109 is identified, and therefore the associated direction data and the infrared transmission code associated to the TV. The processor 104 changes the direction of the transmitter so that the transmitter points substantially directly towards the TV. The actual command to perform an action in the user's speech command, i.e. “turn on the TV” is subsequently performed e.g. where the transmitter transmits the resulting infrared command. Also, if the device 100 deduces from internal reasoning, e.g. interpreting the results of an electronic program guide application, to send a command to the TV 109, the transmitter will be turned and transmits a command data using e.g. traditional remote control with low energy.

FIG. 2 shows a flow chart of one embodiment of a setup phase for the control device described in FIG. 1. After starting the device (S) 201 the setup phase (S_P) 203 is entered. This may be indicated by the user by e.g. saying, “the TV is located here”. The control device may be pre-programmed in a way that the data representing the word “located”, or the combination of data representing the words in the sentence instructs the device to enter a setup phase (S_P) 203. Also, the user could enter the setup phase by simply saying; “please, enter the setup phase”. Other possibilities are inherently also possible to enter the setup phase, e.g. manually selecting a setup phase on the control device by a keyboard command or pressing the respective buttons on the control device. Now, when the control device is in the setup phase, it must be provided with identification data which uniquely identify the target devices (S_P) 203. This may be done by the user by using speech command. The information may be included in the initial speech command, “the TV Philips 28PT5007 is located here”, where the data representing the target devices TV along with the additional details is known by the device. The transmission direction is then determined (P_T_C) 207 (the transmission direction could be determined prior to provided with data which indicates the type of device), e.g. by using computer vision technique as discussed previously or acoustic localization technique. The pointing position is then associated (A_P_D) 209 with the identification data of the target device and stored. If there are more devices to install, the steps (S_P) 205, (P_T_C) 207 and (A_P_D) 209 are repeated. Otherwise, the setup phase is ended (E) 213. Again, the setup phase could be ended by the user through a speech command, e.g. “please end the setup phase”.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word ‘comprising’ does not exclude the presence of other elements or steps than those listed in a claim. The invention can be implemented by means of hardware comprising several distinct elements, and by means of a suitably programmed computer. In a device claim enumerating several means, several of these means can be embodied by one and the same item of hardware. The mere fact that certain measures are recited in mutually different dependent claims does not indicate that a combination of these measures cannot be used to advantage.

1. A method of remotely controlling target devices via an interface device, based on an input from a user comprising information identifying at least one target device and an action to be performed on said at least one target device, wherein the interface device is adapted for directly transmitting a control signal based on said input in a direction towards said least one of said target device, wherein the transmission direction is controllable using setup data stored at said interface device, wherein the setup data is obtained during setup phase of the interface device and comprises:
identification data for uniquely identifying said target devices, and
direction data associated to each of said identification data for identifying said transmission direction,
wherein based on the user's input to perform said action on said at least one target device,
using the direction data associated to the identification data of said at least one target device for controlling the transmission direction towards said at least one target device.

2. A method according to claim 1, wherein the input from said user comprises a speech signal.

3. A method according to claim 1, wherein the identification data are obtained through a speech signal from said user.

4. A method according to claim 1, wherein the direction data associated to each of said identification data comprises data obtained using a computer vision device and the user as a reference point for said computer vision device.

5. A method according to claim 1, wherein the direction data associated to each of said identification data comprises data obtained using a computer vision device adapted to visual identify the target devices.

6. A method according to claim 1, wherein the direction data comprises data obtained using an acoustic localization device and the user as a reference point for said acoustic localization device.

7. A method according to claim 1, further comprising automatically performing commands on said target devices.

8. A computer readable medium having stored therein instructions for causing a processing unit to execute method of claim 1.

9. A control device to be used as an interface between a user and target devices for remotely controlling said target devices based on an input from said user comprising information identifying at least one target device and an action to be performed on said at least one target device, wherein the control device comprises:
a transmitter for directly transmitting a control signal based on said input in a direction towards said least one of said target device,
a setup equipment to be used during a setup phase for obtaining setup data for said control device, wherein the setup data comprises identification data for uniquely identifying said target devices, and direction data associated to each of said identification data for identifying said transmission direction, and
a controller for, based on the user's input to perform said action on said at least one target device, controlling the transmission direction using the direction data associated to the identification data of said at least one target device.

10. A control device according to claim 9, wherein the setup equipment comprises an acoustic sensor arranged on a rotator and a coordinate system connected to the rotator.

11. A control device according to claim 9, wherein the setup equipment comprises a camera arranged on a rotator and a coordinate system connected to the rotator.

12. A control device according to claim 9, further comprising a dialogue system for extracting said information from the user input.
